(19) United States
(12) Patent Application Publication
(10) Pub. No.: US 2015/0339008 A1
(43) Pub. Date: Nov. 26, 2015

(54) METHOD FOR CONTROLLING DISPLAY AND ELECTRONIC DEVICE

(71) Applicant: Samsung Electronics Co., Ltd., Suwon-si (KR)

(72) Inventors: Min Hee LEE, Seoul (KR); Ha Young KIM, Ansan-si (KR); Soo Jung BAE, Seoul (KR); Ho Young LEE, Seoul (KR); Hye Ryoung CHOI, Gwangmyeong-si (KR); Chul Ho JANG, Seoul (KR); Hui Chul YANG, Yongin-si (KR)

(21) Appl. No.: 14/720,024

(22) Filed: May 22, 2015

(30) Foreign Application Priority Data
May 26, 2014 (KR) 10-2014-0063250

(51) Int. Cl. G06F 3/0482; G06F 3/0484

(52) U.S. Cl. CPC G06F 3/0482; G06F 3/04847; G06F 3/04842

(57) ABSTRACT

An electronic device is provided. The electronic device includes a first display and a second display as display areas. The second display outputs at least one item associated with a task performed by a first application executed on the first display and outputs a menu for selecting at least one second application capable of performing the task by using the at least one item.

### CROSS-REFERENCE TO RELATED APPLICATION(S)

This application claims the benefit under 35 U.S.C. §119(a) of a Korean patent application filed on May 26, 2014 in the Korean Intellectual Property Office and assigned Serial number 10-2014-0063250, the entire disclosure of which is hereby incorporated by reference.

### TECHNICAL FIELD

The present disclosure relates to a display controlling method and an electronic device.

### BACKGROUND

Currently, preferences for a user interface (UI) and a user experience (UX) that consider a user and provide a user-friendly user environment have been increasing. In this environment, the UI and UX are recognized as interaction point between a user and an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a display controlling method and an electronic device.

Another aspect of the present disclosure is to provide a computer-readable recording medium containing a program, the program, when executed by a computer, causing the computer to perform the display controlling method.

In accordance with an aspect of the present disclosure, an electronic device is provided. The electronic device includes a display module including a first display and a second display as display areas and a controller configured to output, on the second display, at least one item associated with a task performed by a first application executed on the first display and to output a menu for selecting at least one second application, which is capable of performing the task, by using the at least one item.

In accordance with another aspect of the present disclosure, a display control method is provided. The display control method includes determining a task performed by a first application executed on a first display of an electronic device including the first display and a second display as display areas, outputting at least one item associated with the task on the second display, determining at least one second application capable of executing the task by using the at least one item, and outputting a menu for selecting the at least one second application on the second display.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating an electronic device according to various embodiments of the present disclosure;

FIG. 2 is a block diagram schematically illustrating an electronic device according to various embodiments of the present disclosure;

FIG. 3 is a block diagram schematically illustrating an electronic device according to various embodiments of the present disclosure;

FIG. 4 is a block diagram illustrating an electronic device according to various embodiments of the present disclosure;

FIG. 5 illustrates user interface screens output at a first display and a second display of an electronic device according to various embodiments of the present disclosure;

FIG. 6 illustrates user interface screens output at a first display and a second display of an electronic device according to various embodiments of the present disclosure;

FIG. 7 illustrates user interface screens output at a first display and a second display of an electronic device according to various embodiments of the present disclosure;

FIG. 8 illustrates user interface screens output at a first display and a second display of an electronic device according to various embodiments of the present disclosure;

FIG. 9 illustrates user interface screens output at a first display and a second display of an electronic device according to various embodiments of the present disclosure; and

FIG. 10 is a flow chart indicating a display control method executed at an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

The meaning of the term “or” or “at least one of A and/or B” used herein includes any combination of words listed together with the term. For example, the expression “A or B” or “at least one of A and/or B” may indicate A, B, or both A and B.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, etc.) is referred to as being “connected” to another part (or element, device, etc.), it should be understood that the former may be “directly connected” to the latter, or “electrically connected” to the latter via an intervening part (or element, device, etc.). It will be further understood that when one component is referred to as being “directly connected” or “directly linked” to another component, it means that no intervening component is present.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

Electronic devices according to various embodiments of the present disclosure may include a metal case. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), Moving Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances including metal cases. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

According to various embodiments of the present disclosure, the electronic devices may include at least one of medical devices (e.g., a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), and points of sales (POSs) including metal cases.

According to various embodiments of the present disclosure, the electronic devices may include at least one of parts of furniture or buildings/structures having communication functions, electronic boards, electronic signature receiving devices, projectors, and measuring instruments (e.g., water meters, electricity meters, gas meters, and wave meters) including metal cases. The electronic devices according to various embodiments of the present disclosure may be one or more combinations of the above-mentioned devices. Furthermore, the electronic devices according to various embodiments of the present disclosure may be flexible devices. It would be obvious to those skilled in the art that the electronic devices according to various embodiments of the present disclosure are not limited to the above-mentioned devices.

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

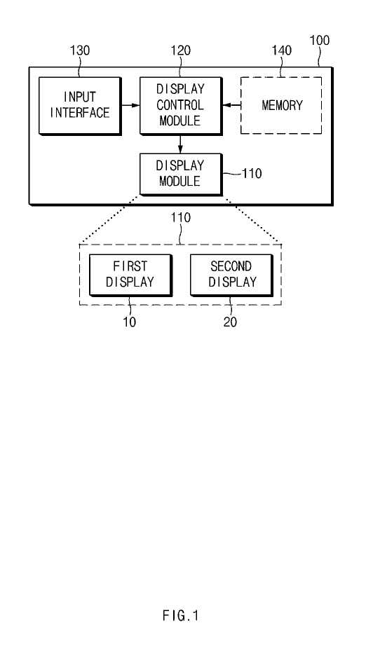

FIG. 1 is a block diagram schematically illustrating an electronic device according to various embodiments of the present disclosure.

Referring to FIG. 1, an electronic device 100 may contain a display module 110, a controller or a display control module 120, and an input interface 130. In this specification, components associated with the embodiment of the present disclosure will be merely described to prevent the scope of the present disclosure from becoming ambiguous. Accordingly, it will be understood that other universal components as well as components illustrated in FIG. 1 are further included.

According to various embodiments of the present disclosure, the display module 110 may include the following display devices and hardware and software modules for driving the display devices: a touch screen, a liquid crystal display (LCD), a thin film transistor-LCD (TFT-LCD), an organic light-emitting diode (OLED), a flexible display, a three-dimensional (3D) display, and the like.

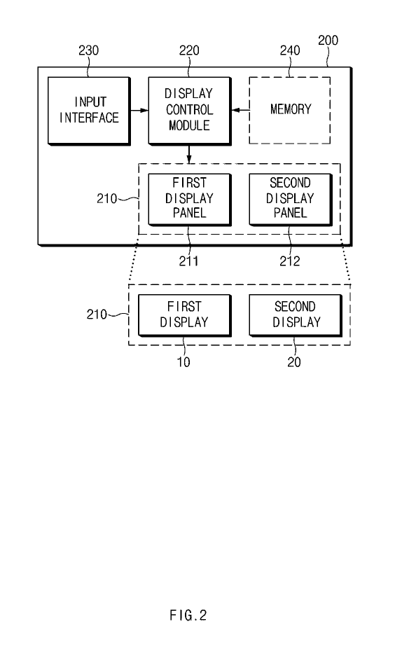

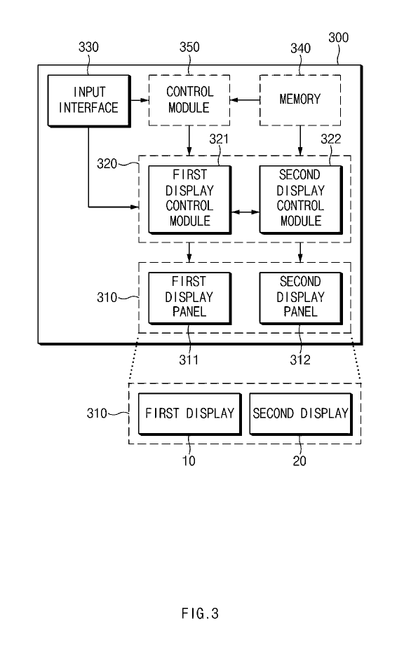

The display module 110 of the electronic device 100 according to various embodiments of the present disclosure may include a plurality of displays that is functionally segmented. The plurality of displays functionally segmented may be implemented by dividing one display panel into a plurality of display areas, or the plurality of displays may be implemented with separate display panels, respectively. The display module 110 of the electronic device 100 according to an embodiment of the present disclosure may be illustrated as one display panel is divided into a plurality of display areas. An embodiment of the present disclosure in which plural displays are respectively implemented with separate display panels will be more fully described with reference to FIGS. 2 and 3.

Below, for the sake of easy description, the display module 110 including a display area divided into a first display 10 and a second display 20 may be exemplified. The scope and spirit of the present disclosure may not be limited thereto, and the display module 110 may include a plurality of, for example, three or more display areas functionally segmented.

The display module 110 may include the first display 10 and the second display 20 as functionally segmented display areas.

For example, the display module 110 may include the first display 10 as a main screen and the second display 20 as a sub screen. Furthermore, the display module 110 may include the first display 10 at a front surface of the electronic device 100 and the second display 20 at a side surface thereof. As another example, in the case where the display module 110 includes a flexible display, the first display 10 may set the first display 10 to an area on a flat display area and may set the second display 20 to an area on a flexible display panel. The scope and spirit of the present disclosure may not be limited thereto, and the display module 110 may include the first display 10 and the second display 20, for example, in various shapes.

The display module 110 may display information processed in the electronic device 100 on the first display 10 and/or the second display 20. For example, the display module 110 may output various objects, such as an icon, a menu, an image, a text, a list, a scroll, and the like, on at least one of the first display 10 and/or the second display 20.

The controller or the display control module 120 may control the display module 110 so as to output at least one item on a task to be executed by a first application running, to the second display 20. The first application may be an application running at the first display 10 and may be distinguishable from at least one second application that is not executed at the electronic device 100.

For example, the task may indicate at least one task that is capable of being performed by the first application. For example, in the case where the first application is an application associated with multimedia reproduction, the task may be to reproduce a multimedia file. Alternatively, in the case where the first application is an application associated with photographing, the task may be to take a picture or video. Still alternatively, in the case where the first application is an application associated with an image, the task may be to edit the image. In the case where the first application is an application associated with sound reproduction, the task may be to reproduce sound. As such, the task may include various tasks, such as reproduction of multimedia, photographing, storage of an image, edition of an image, and the like.

At least one item associated with the task may be a selection menu for providing a menu selectable when the first application executes the task. Alternatively, the at least one item may be a control menu for controlling a function of the first application. As other example, the at least one item may be a function menu that the first application may execute. The at least one item may not be limited to the control menu, the selection menu, or the function menu, and may variously include objects, menus, icons, and the like associated with the task.

Furthermore, the controller or the display control module 120 may control the display module 110 so as to output, to the second display 20, a menu for selecting at least one second application, which may execute the task, using the at least one item.

For example, the second application may include at least one application that may execute the same task as executed by the first application, using the at least one item. For example, in the case where the at least one item corresponds to a control menu for controlling reproduction of multimedia, the second application may be another application capable of controlling the reproduction of multimedia using the control menu. Alternatively, in the case where the at least one item corresponds to a control menu for setting a photographing condition, the second application may be an application capable of setting a photographing condition using the control menu. As another example, in the case where the at least one item corresponds to a selection menu for providing a file format selectable in storing an image, the second application may be an application capable of storing an image the selection menu. As still another example, in the case where the at least one item corresponds to a control menu for controlling a volume of sound reproduced, the second application may be an application capable of controlling a volume of reproduced sound using the control menu.

When there is received a user input for selecting the at least one second application displayed on the second display 20, the controller or the display control module 120 may control the display module 110 such that the second application thus selected is executed at the first display 10. The second application thus selected may use the at least one item displayed at the second display 20.

For example, in the case where the at least one item corresponds to a control menu for controlling reproduction of multimedia, the second application thus selected may control to reproduce multimedia using the control menu. Alternatively, in the case where the at least one item corresponds to a control menu for setting a shooting condition, the second application thus selected may set a photographing condition using the control menu. As another example, in the case where the at least one item corresponds to a selection menu for providing a file format selectable in storing an image, the second application may be an application capable of storing an image the selection menu. As still another example, in the case where the at least one item corresponds to a control menu for controlling a volume of sound reproduced, the second application may control (or adjust) a volume of reproduced sound using the control menu.

When a new application is received (i.e., downloaded) at the electronic device 100, the controller or the display control module 120 may check an attribute of the new application. When the new application has an attribute common to the first application, the controller or the display control module 120 may include the new application in the at least one second application and control to output the menu to the second display 20.

For example, when receiving a new application, the electronic device 100 may receive information associated with the new application. The information associated with the new application may include an attribute of the new application, control information for controlling the new application, information on a task to be executed by the new application, and the like. The controller or the display control module 120 may check an attribute of the new application to determine whether to output the attribute to the second display 20 as at least one second application capable of using the at least one item. When the new application has an attribute common to the first application, the controller or the display control module 120 may control to output the new application to the second display 20 as the at least one second application.

According to various embodiments of the present disclosure, when a first application associated with a contact is running at the first display 10, the second display 20 may output a function menu for sending or rejecting a call. Furthermore, the second display 20 may output at least one second application (e.g., voice over Internet protocol (VoIP) call application, call application, and the like) that is capable of using the function menu for sending or rejecting a call.

According to various embodiments of the present disclosure, when a first application associated with search is running at the first display 10, the second display 20 may output an object (search window) that is usable in searching. Furthermore, the second display 20 may output at least one second application (e.g., various engines and the like) that are usable in searching.

The input interface 130 may receive a user input about at least one of the first display 10 or the second display 20. For example, the input interface 130 may receive a touch input from a user. As another example, the input interface 130 may receive a sound input from the user. As still another example, the input interface 130 may receive a specific gesture from the user. However, the scope and spirit of the present disclosure may not be limited thereto. For example, the input interface 130 may receive user inputs in various forms.

According to various embodiments of the present disclosure, the input interface 130 may include the following input devices and hardware and software modules for driving the input devices: a microphone, a key pad, a dome switch, a touch pad (capacitive/resistive), a touch screen, a jog wheel, a jog switch, a hardware (H/W) button, and the like. Alternatively, the input interface 130 may further include a gesture sensor capable of detecting rotation or movement of the electronic device 100 or a user gesture, a Gyro sensor, a magnetic sensor, an acceleration sensor, a proximity sensor, and the like.

According to various embodiments of the present disclosure, the electronic device 100 may further include a memory 140. The memory 140 may be a typical storage medium and may store information about an attribute of an application. The memory 140 may store control information for controlling an application, information about a task executed by an application, and the like. Besides, the memory 140 may store data needed to display information at the first display 10 and the second display 20. The memory 140 may store an instruction set or a program routine needed to segment the display module 110 into the first display 10 and the second display 20. Furthermore, the memory 140 may store data and/or a program(s) that are needed for the controller or the display control module 120 to control the display module 110.

According to various embodiments of the present disclosure, the memory 140 may include a hard disk drive (HDD), a read only memory (ROM), a random access memory (RAM), a flash memory, a memory card, a not and (NAND) memory, a solid state drive (SSD), and the like.

FIG. 2 is a block diagram schematically illustrating an electronic device according to various embodiments of the present disclosure.

Referring to FIG. 2, an electronic device 200 may contain a display module 210, a controller or a display control module 220, and an input interface 230. The display module 210 according to an embodiment of the present disclosure may include a first display panel 211 and a second display panel 212. The electronic device 200 according to various embodiments of the present disclosure may further include a memory 240.

The display module 210 of the electronic device 200 according to an embodiment of the present disclosure may be illustrated as being implemented with separate display panels, respectively.

Below, for the sake of easy description, a display module 210 including two segmented display areas, for example, a first display 10 and a second display 20 may be exemplified. Referring to FIG. 2, the first display 10 may be set on the first display panel 211, and the second display 20 may be set on the second display panel 212.

The controller or the display control module 220, the input interface 230, and the memory 240 illustrated in FIG. 2 may correspond to a controller or a display control module 120, an input interface 130, and a memory 140 illustrated in FIG. 1, and a duplicated description is thus omitted.

The display module 210 may include the first display 10 and the second display 20 as functionally segmented display areas. The first display 10 may be set on the first display panel 211, and the second display 20 may be set on the second display panel 212.

For example, in the display module 210, the first display panel 211 is a flat display panel and the second display panel 212 is a flexible display panel. As another example, in the display module 210, the first display panel 211 may be a display panel placed at a front surface of the electronic device 200 and the second display panel 212 may be a display panel placed at a side surface thereof. However, the scope and spirit of the present disclosure may not be limited thereto. For example, the first display panel 211 and the second display panel 212 of the display module 210 may be disposed (or arranged) in various shapes.

The display module 210 may display information processed in the electronic device 200. The display module 210 may output various objects, such as an icon, a menu, an image, a text, a list, a scroll, and the like, on at least one of the first display 10 and/or the second display 20.

According to various embodiments of the present disclosure, each of the first display panel 211 and the second display panel 212 of the display module 210 may be formed of a display device such as a touch screen, a TFT-LCD, an OLED, a flexible display, a 3D display, and the like.

The first display panel 211 and the second display panel 212 may be controlled by one display control module 220.

FIG. 3 is a block diagram schematically illustrating an electronic device according to various embodiments of the present disclosure.

Referring to FIG. 3, an electronic device 300 may include a display module 310, a controller or a display control module 320, and an input interface 330. The display module 310 according to an embodiment of the present disclosure may include a first display panel 311 and a second display panel 312, and the controller or the display control module 320 may include a first controller or a first display control module 321 and a second controller or a second display control module 322. The electronic device 300 according to various embodiments of the present disclosure may further include at least one of a memory 340 or a control module 350.

The display module 310 of the electronic device 300 according to an embodiment of the present disclosure may be illustrated as a plurality of displays functionally segmented is formed of separate display panels, respectively. In comparison with FIG. 2, a plurality of display panels of the display module 310 illustrated in FIG. 3 may be controlled through a plurality of display control modules, respectively.

Below, for the sake of easy description, the display module 310 including two segmented display areas, for example, a first display 10 and a second display 20 may be exemplified. Referring to FIG. 3, the first display 10 may be set on the first display panel 311, and the second display 20 may be set on the second display panel 312. The first display panel 311 may be controlled by the first controller or the first display control module 321, and the second display panel 312 may be controlled by the second controller or the second display control module 322.

The controller or the display control module 320, the input interface 330, and the memory 340 illustrated in FIG. 3 may correspond to a controller or a display control module 120, an input interface 130, and a memory 140 illustrated in FIG. 1, and a duplicated description is thus omitted.

The display module 310 may include the first display 10 and the second display 20 as functionally segmented display areas. The first display 10 may be set on the first display panel 311, and the second display 20 may be set on the second display panel 312.

For example, in the display module 310, the first display panel 311 may be a flat display panel and the second display panel 312 may be a flexible display panel. As another example, in the display module 310, the first display panel 311 may be a display panel placed at a front surface of the electronic device 300 and the second display panel 312 may be a display panel placed at a side surface thereof. However, the scope and spirit of the present disclosure may not be limited thereto. For example, the first display panel 311 and the second display panel 312 of the display module 310 may be disposed (or arranged) in various shapes.

The display module 310 may display information processed in the electronic device 300. The display module 310 may output various objects, such as an icon, a menu, an image, a text, a list, a scroll, and the like, on at least one of the first display 10 and/or the second display 20.

According to various embodiments of the present disclosure, each of the first display panel 311 and the second display panel 312 of the display module 310 may be formed of a display device such as a touch screen, a TFT-LCD, an OLED, a flexible display, a 3D display, and the like.

The first display panel 311 and the second display panel 312 may be controlled by the first controller or the first display control module 321 and the second controller or the second display control module 322, respectively.

The controller or the display control module 320 may be formed of the first controller or the first display control module 321 and the second controller or the second display control module 322. The first controller or the first display control module 321 may control the first display panel 311. The second controller or the second display control module 322 may control the first display panel 311. The first controller or the first display control module 321 and the second controller or the second display control module 322 may be included in separate integrated circuits or in an integrated circuit (IC) package.

The display module 310 may be the same as display control modules 120 and 220 illustrated in FIGS. 1 and 2 except that the display module 310 is controlled by the first controller or the first display control module 321 and the second controller or the second display control module 322; hence, a description given with respect to FIGS. 1 and 2 and associated with the controller or the display control modules 120 and 220 may be applied to the controller or the display control module 320 illustrated in FIG. 3. With regard to this, a duplicated description may be thus omitted.

According to various embodiments of the present disclosure, the electronic device 300 may further include a control module 350. For example, the controller or the display control module 320 may directly receive a signal from the input interface 330 or the memory 340 to control the display module 310. Alternatively, the controller or the display control module 320 may receive a control signal from the control module 350, which receives a signal from the input interface 330 or the memory 340, to control the display module 310.

The controller or the display control modules 120 and 220 illustrated in FIGS. 1 and 2 may be illustrated as controlling display modules 110 and 210 in response to a signal directed received from input interfaces 130 and 230 or memories 140 and 240. However, the scope and spirit of the present disclosure may not be limited thereto. For example, the controller or the display control modules 120 and 220 illustrated in FIGS. 1 and 2 may receive control signals from control modules, which receive signals from the input interfaces 130 and 230 or the memories 140 and 240, to control the display module 310.

The control module 350 may control an overall operation of the electronic device 300 as well as an operation of the controller or the display control module 320, the input interface 330, or the memory 340. For example, the control module 350 may correspond to an application processor (AP).

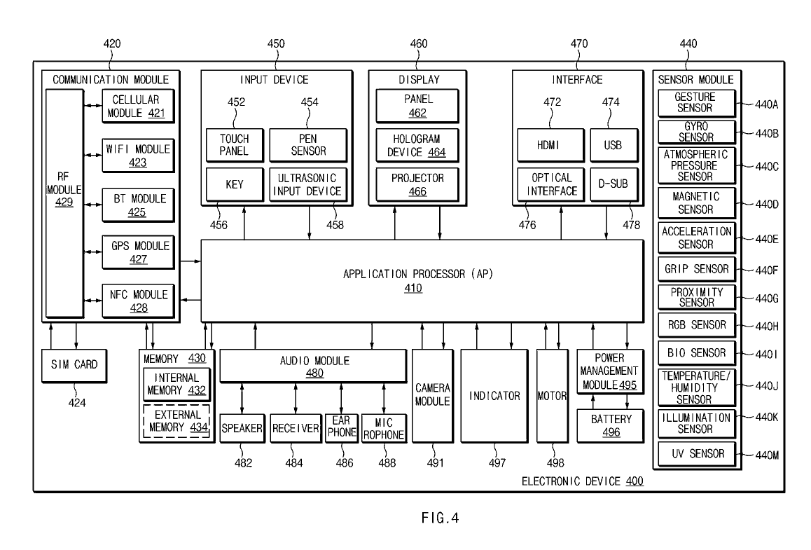

FIG. 4 is a block diagram illustrating an electronic device according to various embodiments of the present disclosure.

Referring to FIG. 4, an electronic device 400 may include a part or all of components of one of electronic devices 100, 200, and 300 shown in FIGS. 1 to 3. The electronic device 400 may include one or more APs 410, a communication module 420, a subscriber identification module (SIM) card 424, a memory 430, a sensor module 440, an input device 450, a display module 460, an interface 470, an audio module 480, a camera module 491, a power management module 495, a battery 496, an indicator 497, and a motor 498.

The AP 410 (e.g., a control module 350 illustrated in FIG. 3) may drive an operating system (OS) or an application to control a plurality of hardware or software components connected to the AP 410 and may process and compute a variety of data including multimedia data. The AP 410 may be implemented with a System on Chip (SoC), for example. According to an embodiment of the present disclosure, the AP 410 may further include a graphic processing unit (GPU) (not illustrated).

The communication module 420 may transmit and receive data when there are conveyed communications between other electronic devices connected with the electronic device 400 through a network. According to an embodiment of the present disclosure, the communication module 420 may include a cellular module 421, a Wi-Fi module 423, a Bluetooth (BT) module 425, a GPS module 427, a near field communication (NFC) module 428, and a radio frequency (RF) module 429.

The cellular module 421 may provide voice communication, video communication, a character service, an Internet service, and the like through a communication network (e.g., a long term evolution (LTE), an LTE-advanced (LTE-A), a code division multiple access (CDMA), a wideband CDMA (WCDMA), a universal mobile telecommunications system (UMTS), a wireless broadband (WiBro), a global system for mobile communications (GSM), and the like). Also, the cellular module 421 may perform discrimination and authentication of an electronic device within a communication network using a subscriber identification module (e.g., a SIM card 424), for example. According to an embodiment of the present disclosure, the cellular module 421 may perform at least a portion of functions that the AP 410 provides. For example, the cellular module 421 may perform at least a portion of a multimedia control function.

According to an embodiment of the present disclosure, the cellular module 421 may include a communication processor (CP). Furthermore, the cellular module 421 may be implemented with, for example, an SoC. Although components such as the cellular module 421 (e.g., a CP), the memory 430, the power management module 495, and the like are illustrated as being components independent of the AP 410, the AP 410 according to an embodiment of the present disclosure may be implemented to include at least a portion (e.g., a cellular module 421) of the above components.

According to an embodiment of the present disclosure, the AP 410 or the cellular module 421 (e.g., a CP) may load and process an instruction or data received from nonvolatile memories respectively connected thereto or from at least one of other elements at the nonvolatile memory. Also, the AP 410 or the cellular module 421 may store data received from at least one of other elements or generated by at least one of other elements at a nonvolatile memory.

Each of the Wi-Fi module 423, the BT module 425, the GPS module 427, and the NFC module 428 may include a processor for processing data exchanged through a corresponding module, for example. In FIG. 4, the cellular module 421, the Wi-Fi module 423, the BT module 425, the GPS module 427, and the NFC module 428 may be illustrated as being separate blocks, respectively. According to an embodiment of the present disclosure, at least a portion (e.g., two or more components) of the cellular module 421, the Wi-Fi module 423, the BT module 425, the GPS module 427, and the NFC module 428 may be included within one IC or an IC package. For example, at least a portion (e.g., a CP corresponding to the cellular module 421 and a Wi-Fi processor corresponding to the Wi-Fi module 423) of CPs corresponding to the cellular module 421, the Wi-Fi module 423, the BT module 425, the GPS module 427, and the NFC module 428 may be implemented with one SoC.

The RF module 429 may transmit and receive data, for example, an RF signal. Although not illustrated, the RF module 429 may include a transceiver, a power amplifier module (PAM), a frequency filter, or low noise amplifier (LNA). Furthermore, the RF module 429 may further include the following part for transmitting and receiving an electromagnetic wave in a space in wireless communication: a conductor or a conducting wire. In FIG. 4, the cellular module 421, the Wi-Fi module 423, the BT module 425, the GPS module 427, and the NFC module 428 may be illustrated as sharing one RF module 429, but according to an embodiment of the present disclosure, at least one of the cellular module 421, the Wi-Fi module 423, the BT module 425, the GPS module 427, or the NFC module 428 may transmit and receive an RF signal through a separate RF module.

The SIM card 424 may be a card that includes a subscriber identification module and may be inserted to a slot formed at a specific position of the electronic device 400. The SIM card 424 may include unique identify information (e.g., IC card identifier (ICCID)) or subscriber information (e.g., integrated mobile subscriber identity (IMSI)). The SIM card 424 may store an application and the like that are received from an external device and are installed and may store an app icon of the application. The SIM card 424 may store an icon, which is bookmarked by a user, from among the app icon and a symbol icon.

The memory 430 may include an internal memory 432 or an external memory 434. For example, the internal memory 432 may include at least one of a volatile memory (e.g., dynamic RAM (DRAM), static RAM (SRAM), synchronous dynamic RAM (SDRAM), etc.), or a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). The memory 430 may store an application and the like that are received from an external device and are installed and may store an app icon of the application. The memory 430 may store an icon, which is bookmarked by a user, from among the app icon and a symbol icon.

According to an embodiment of the present disclosure, the internal memory 432 may be an SSD. The external memory 434 may include a flash drive, for example, compact flash (CF), secure digital (SD), Micro-SD, Mini-SD, extreme digital (xD) or a memory stick. The external memory 434 may be functionally connected with the electronic device 400 through various interfaces. According to an embodiment of the present disclosure, the electronic device 400 may further include a storage device (or storage medium) such as a hard disk drive.

The sensor module 440 may measure a physical quantity or may detect an operation state of the electronic device 400. The sensor module 440 may convert the measured or detected information to an electric signal. The sensor module 440 may include at least one of a gesture sensor 440A, a gyro sensor 440B, a pressure sensor 440C, a magnetic sensor 440D, an acceleration sensor 440E, a grip sensor 440F, a proximity sensor 440G, a color sensor 440H (e.g., red, green, blue (RGB) sensor), a living body sensor (BIO) 440I, a temperature/humidity sensor 440J, an illuminance sensor 440K, or an ultraviolet (UV) sensor 440M. Additionally or generally, although not illustrated, the sensor module 440 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 440 may further include a control circuit for controlling at least one or more sensors included therein. The sensor module 440 may sense (or detect) directivity of the electronic device 400 using the Gyro sensor 440B and the like, and may convert information about the sensed directivity into an electrical signal to provide it to the AP 410.

The input device 450 (e.g., an input interface 130 illustrated in FIG. 1) may include a touch panel 452, a (digital) pen sensor 454, a key 456, or an ultrasonic input unit 458. The touch panel 452 may recognize a touch input using at least one of capacitive, resistive, infrared and ultrasonic detecting methods. Also, the touch panel 452 may further include a control circuit. In the case of using the capacitive detecting method, a physical contact or proximity recognition is possible. The touch panel 452 may further include a tactile layer. In this case, the touch panel 452 may provide a tactile reaction to a user. The touch panel 452 may generate a touch event associated with execution of a specific function using position associated information.

The (digital) pen sensor 454 may be implemented in a similar or same manner as the method of receiving a touch input of a user or may be implemented using an additional sheet for recognition. The key 456 (e.g., an input interface 130) may include, for example, a physical button, an optical key, or a keypad. The ultrasonic input device 458, which is an input device for generating an ultrasonic signal, may enable the electronic device 400 to sense detect a sound wave so as to identify data, wherein the ultrasonic input device 458 is capable of wireless recognition. According to an embodiment of the present disclosure, the electronic device 400 may use the communication module 420 so as to receive a user input from an external device (e.g., a computer or server) connected to the communication module 420.

The display module 460 (e.g., a display module 110 illustrated in FIG. 1) may include a panel 462, a hologram device 464, or a projector 466. According to an embodiment of the present disclosure, the display module 460 may include a control circuit for controlling the panel 462, the hologram device 464, or the projector 466. The panel 462 may be a liquid-crystal display or an active-matrix OLED (AMOLED). The panel 464 may be, for example, flexible, transparent or wearable. The panel 464 and the touch panel 452 may be integrated into a single module. The hologram device 464 may display a stereoscopic image in a space using a light interference phenomenon. The projector 466 may project light onto a screen so as to display an image. The screen may be arranged in the inside or the outside of the electronic device 400. According to an embodiment of the present disclosure, the display 460 may further include a control circuit for controlling the panel 462, the hologram device 464, or the projector 466. Under a control of the AP 410, the display module 460 may output an execution screen about a function that is being executed on a first output area may output items, such as an icon, a menu, a text, and the like, on a second output area. Herein, the icon of the items may an attribute control icon associated with a specific function for providing an execution screen, an app icon associated with an application, a symbol icon associated with a web site, or a state icon associated with an indicator. The menu of the items may be a zoon control of image data, a volume control of sound data, and the like, and the text thereof may be a text including a notification message about an operation of a previously installed application, a web URL address, and the like.

The interface 470 may include, for example, a high-definition multimedia interface (HDMI) 472, a universal serial bus (USB) 474, an optical interface 476, or a D-sub (D-subminiature) 478. Additionally or generally, the interface 470 may include, for example, a mobile high definition link (MHL) interface, a SD card/multi-media card (MMC) interface, or an infrared data association (IrDA) standard interface.

The audio module 480 may convert a sound and an electric signal in dual directions. The audio module 480 may process, for example, sound information that is input or output through a speaker 482, a receiver 484, an earphone 486, or a microphone 488.

According to an embodiment of the present disclosure, the camera module 491 for photographing a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 495 may manage power of the electronic device 400. Although not illustrated, the power management module 495 may include, for example, a power management IC (PMIC) a charger IC, or a battery or fuel gauge.

The PMIC may be mounted on an integrated circuit or an SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge may measure, for example, a remaining capacity of the battery 496 and a voltage, current or temperature thereof while the battery is charged. The battery 496 may store or generate electricity, and may supply power to the electronic device 400 using the stored or generated electricity. The battery 496 may include, for example, a rechargeable battery or a solar battery.

The indicator 497 may display a specific state of the electronic device 400 or a part thereof (e.g., the AP 410), such as a booting state, a message state, a charging state, and the like. The motor 498 may convert an electrical signal into a mechanical vibration. Although not illustrated, a processing device (e.g., a GPU) for supporting a mobile TV may be included in the electronic device 400. The processing device for supporting a mobile TV may process media data according to the standards of digital multimedia broadcasting (DMB), digital video broadcasting (DVB) or media flow.

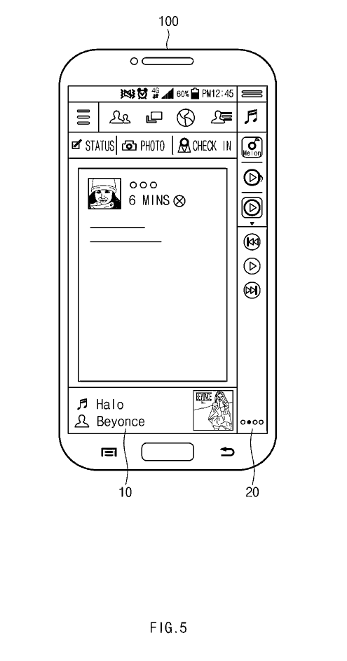

FIG. 5 illustrates user interface screens output at a first display and a second display of an electronic device according to various embodiments of the present disclosure.

Referring to FIG. 5, an electronic device 100 may output a first application, which is an application associated with multimedia reproduction, to a first display 10. The first application output to the first display 10 may perform a task for reproducing multimedia.

As described with reference to FIG. 1, a controller or a display control module 120 may output, to a second display 20, at least one item associated with a task executed by the first application which runs at the first display 10. Since the first application is performing the task for reproducing multimedia, at least one item may be a control menu for controlling reproduction of the multimedia. Referring to FIG. 5, the second display 20 may output control menu icons (e.g., play, forward, reward, and the like) for controlling reproduction of the multimedia.

The controller or the display control module 120 may determine at least one second application capable of controlling multimedia using the control menu icon of the second display and may output the at least one second application to the second display. Referring to FIG. 5, the second display 20 may output applications, which are associated with reproduction of the multimedia and use the control menu icons, together with the control menu icons for controlling reproduction of the multimedia.

As such, it may be possible to provide the same control menu for controlling a plurality of applications capable of performing the same task, using functionally segmented displays. If performing the same task, an application, at which a segmented display is not defined, from among the plurality of applications may also use the same control menu. The electronic device 100 according to various embodiments of the present disclosure may improve convenience of a user and may use segmented displays efficiently.

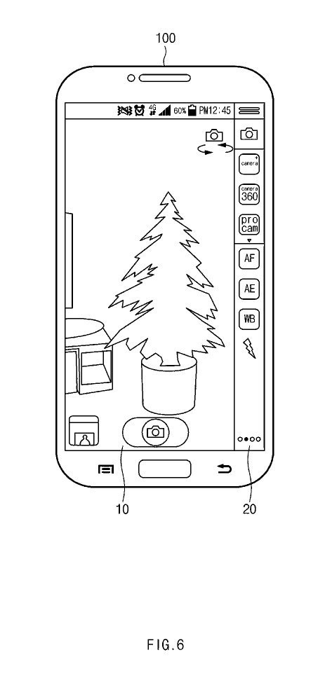

FIG. 6 illustrates user interface screens output at a first display and a second display of an electronic device according to various embodiments of the present disclosure.

Referring to FIG. 6, an electronic device 100 may output a first application, which is associated with photographing, to a first display 10. At the first display 10, the first application may be performing a task for taking a picture.

As described with reference to FIG. 1, a controller or a display control module 120 may output, to a second display 20, at least one item associated with a task that is performed by the first application running at the first display 10. Since the first application is taking a picture, at least one item may be a control menu for setting a photography condition. Referring to FIG. 6, the second display 20 may output control menu icons (e.g., auto focus (AF), auto exposure (AE), white balance (WB), and the like) for setting a photography condition.

The controller or the display control module 120 may determine at least one second application capable of setting a photography condition using a control menu icon displayed at the second display 20 and may output the at least one second application to the second display 20. Referring to FIG. 6, the second display 20 may output applications, which are associated with taking a picture and uses the control menu icons, together with the control menu icons for setting a photographing condition.

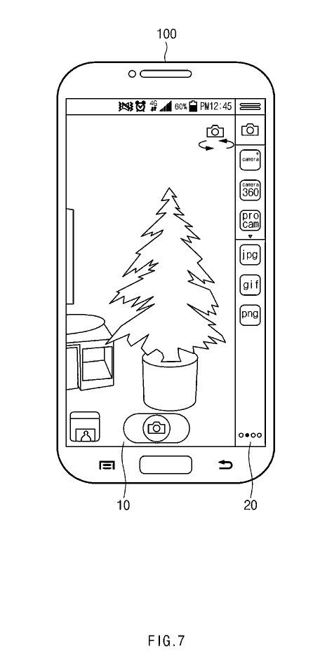

FIG. 7 illustrates user interface screens output at a first display and a second display of an electronic device according to various embodiments of the present disclosure.

Referring to FIG. 7, an electronic device 100 may output a first application, which is an application associated with photographing, to a first display 10. At the first display 10, the first application may be performing a task for storing a captured image.

As described with reference to FIG. 1, a controller or a display control module 120 may output, to a second display 20, at least one item associated with a task that is performed by the first application running at the first display 10. Since the first application is performing a task for storing a captured image, at least one item may be a selection menu for providing file formats selectable in storing an image. Referring to FIG. 7, the second display 20 may output selection menu icons for providing file formats selectable in storing an image. For example, file formats selectable in storing an image may include JPG, GIF, PNG, and the like.

The controller or the display control module 120 may determine at least one second application capable of storing an image using a selection menu icon displayed at the second display 20 and may output the at least one second application to the second display 20. Referring to FIG. 7, the second display 20 may output applications, which are associated with storing an image and uses the selection menu icons, together with the selection menu icons for providing file formats selectable in storing an image.

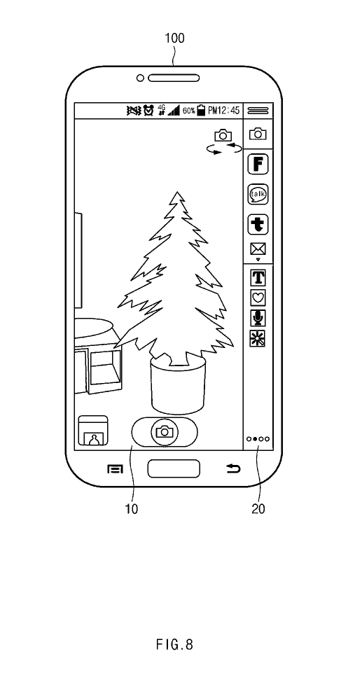

FIG. 8 illustrates user interface screens output at a first display and a second display of an electronic device according to various embodiments of the present disclosure.

Referring to FIG. 8, an electronic device 100 may output a first application, which is an application associated with photographing, to a first display 10. At the first display 10, the first application may be performing a task for editing a captured image.

As described with reference to FIG. 1, a controller or a display control module 120 may output, to a second display 20, at least one item associated with a task that is performed by the first application running at the first display 10. Since the first application is performing a task for editing a captured image, at least one item may be a function menu for providing functions selectable in editing an image. Referring to FIG. 8, the second display 20 may output function menu icons (e.g., a text input, attachment of a sticker, voice over, a brightness control of an image, and the like) for providing functions selectable in editing an image.

The controller or the display control module 120 may determine at least one second application capable of editing an image using a function menu icon displayed at the second display 20 and may output the at least one second application to the second display 20. Referring to FIG. 8, the second display 20 may output applications, which are associated with editing an image and uses the function menu icons, together with the function menu icons for providing functions selectable in editing an image. For example, the at least one second application may be a social network application (e.g., Facebook, Twitter, Kakaotalk messenger, and the like).

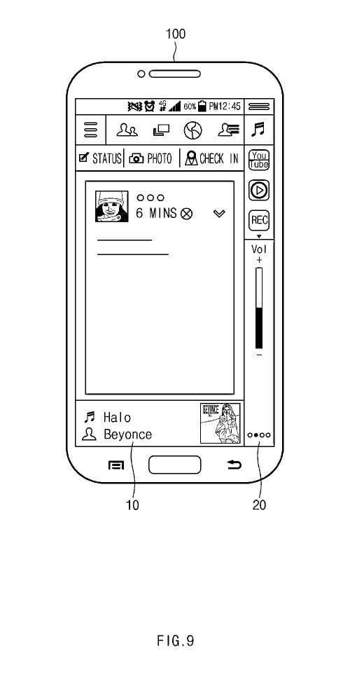

FIG. 9 illustrates user interface screens output at a first display and a second display of an electronic device according to various embodiments of the present disclosure.

Referring to FIG. 9, an electronic device 100 may output a first application, which is an application associated with sound reproduction, to a first display 10. At the first display 10, the first application may be performing a task for reproducing sound. As illustrated in FIG. 9, the first application associated with sound reproduction as well as another application, which is currently running, may be displayed at the first application 10. In FIG. 9, an application for providing a social network service posting a state, a picture, and the like of a user may be displayed at the upper portion of the first display 10, and a first application, which is associated with music and indicates that a song “Halo” (Beyonce) is being played, may be displayed at the lower portion of the first display 10.

As described with reference to FIG. 1, a controller or a display control module 120 may output, to a second display 20, at least one item associated with a task that is performed by the first application running at the first display 10. Since the first application is performing a task for reproducing sound, at least one item may be a control menu for controlling a volume of the sound. Referring to FIG. 9, the second display 20 may output an icon (e.g., a volume control bar) at the control menu for controlling the volume of the sound, in reproducing the sound.

The controller or the display control module 120 may determine at least one second application capable of controlling a volume of sound using a control menu icon displayed at the second display 20 and may output the at least one second application to the second display 20. Referring to FIG. 9, the second display 20 may output applications, which are associated with sound reproduction and uses the control menu icon, together with the control menu icon for controlling a sound volume. For example, the at least one second application may be an application (e.g., a video player) for reproducing a video, an application (e.g., a music player) for reproducing a music, a recording application (e.g., a voice recorder), and the like.

According to an embodiment of the present disclosure, a display module 110 including a first display 10 and/or a second display 20 may contain a flexible display area, the first display 10 may be a flat display area of a display panel, and the second display 20 may be a warped display area. Accordingly, a volume control bar and application icons (e.g., YouTube and the like) capable of using the volume control bar may be placed on the flexible display area.

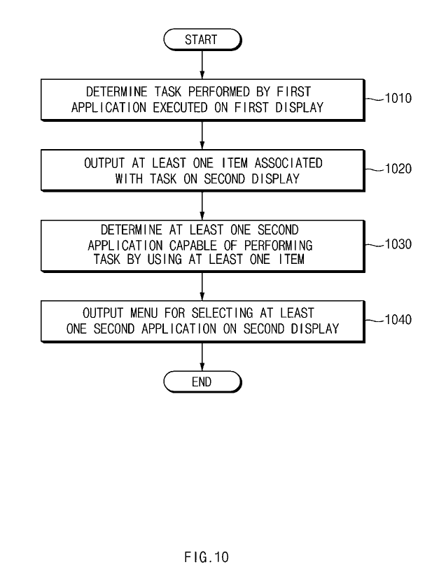

FIG. 10 is a flow chart indicating a display control method executed at an electronic device according to various embodiments of the present disclosure.

Referring to FIG. 10, a display control method may be formed of operations that an electronic device 100, 200, 300, or 400 (refer to FIGS. 1 to 4) processes. Accordingly, the above description associated with the electronic device 100, 200, 300, or 400 (refer to FIGS. 1 to 4) may be applied to the display control method illustrated in FIG. 10.

In operation 1010, a controller or a display control module 120 may determine a task to be executed at a first application running at a first display 10.

In operation 1020, the controller or the display control module 120 may output at least one item associated with the task to a second display 20.

In operation 1030, the controller or the display control module 120 may determine at least one second application, which is capable of performing the task, using at least one item.

In operation 1040, the controller or the display control module 120 may output a menu for selecting the at least one second application to the second display 20.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to various embodiments of the present disclosure may include at least one of an application-specific IC (ASIC) chip, a field-programmable gate array (FPGA), and a programmable-logic device for performing some operations, which are known or will be developed.

According to various embodiments of the present disclosure, at least a portion of an apparatus (e.g., modules or functions thereof) or a method (e.g., operations) according to various embodiments of the present disclosure, for example, may be implemented by instructions stored in a computer-readable storage media in the form of a programmable module. The instruction, when executed by one or more processors (e.g., the application processor 410), may perform a function corresponding to the instruction. The computer-readable storage media, for example, may be the memory 430. At least a portion of the programming module, for example, may be implemented (e.g., executed) by the application processor 410. At least a portion of the programming module may include the following for performing one or more functions: a module, a program, a routine, sets of instructions, or a process.

A computer-readable recording medium may include a hard disk, a magnetic media such as a floppy disk and a magnetic tape, an optical media such as Compact Disc ROM (CD-ROM) and a DVD, a magneto-optical media such as a floptical disk, and the following hardware devices specifically configured to store and perform a program instruction (e.g., a programming module): ROM, RAM, and a flash memory. Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a programming module according to an embodiment of the present disclosure may include at least one of the above elements, or a portion of the above elements may be omitted, or additional other elements may be further included. Operations performed by a module, a programming module, or other elements according to an embodiment of the present disclosure may be executed sequentially, in parallel, repeatedly, or in a heuristic method. Also, a portion of operations may be executed in different sequences, omitted, or other operations may be added.

According to various embodiments of the present disclosure, it may be possible to provide the same control menu or selection menu using segmented displays with respect to a plurality of applications performing the same task. As a consistent user interface is provided with respect to a plurality of applications, the convenience of a user may be improved. Unnecessary data may be reduced by providing a common user interface with respect to a plurality of applications. Furthermore, in the case of using an application where a plurality of segmented displays is not defined, it may be possible to effectively use a plurality of segmented displays using a common user interface.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display module including a first display and a second display as display areas; and
a controller configured to output, on the second display, at least one item associated with a task performed by a first application executed on the first display and a menu for selecting at least one second application, which is capable of performing the task, by using the at least one item.

2. The electronic device of claim 1, further comprising:
an input interface configured to receive a user input on at least one of the first display or the second display, and
wherein if a user input selecting the at least one second application displayed on the second display is received, the controller executes the selected second application on the first display.

3. The electronic device of claim 1, further comprising:
a memory storing information about an attribute of an application,
wherein if a new application is downloaded at the electronic device, the controller is further configured to check an attribute of the new application, and
wherein if the checked attribute of the new application corresponds to an attribute of the first application, the controller is further configured to insert the new application into the menu and outputs, on the second display, the menu including the new application.

4. The electronic device of claim 1, wherein the at least one item corresponds to a selection menu for providing a menu selectable in performing the task.

5. The electronic device of claim 1, wherein the at least one item corresponds to a control menu for controlling a function of the first application.

6. The electronic device of claim 1,
wherein if the first application is an application associated with multimedia playback, the at least one item corresponds to a control menu for controlling the multimedia playback, and
wherein the at least one second application controls the multimedia playback by using the control menu.

7. The electronic device of claim 1,
wherein if the first application is an application associated with photographing, the at least one item corresponds to a control menu for setting a photographing option, and
wherein the at least one second application sets the photographing option by using the control menu.

8. The electronic device of claim 1,
wherein if the first application is an application associated with an image, the at least one item corresponds to a selection menu for providing file formats selectable in storing an image, and
wherein the at least one second application stores an image by using the selection menu.

9. The electronic device of claim 1,
wherein if the first application is an application associated with sound reproduction, the at least one item corresponds to a control menu for controlling a volume of sound reproduced, and
wherein the at least one second application controls a volume of the reproduced sound.

10. A display control method comprising:
determining a task performed by a first application executed on a first display of an electronic device including the first display and a second display as display areas;
outputting at least one item associated with the task on the second display;
determining at least one second application capable of executing the task by using the at least one item; and
outputting a menu for selecting the at least one second application on the second display.

11. The display control method of claim 10, further comprising:
receiving a user input on at least one of the first display or the second display; and
if a user input selecting the at least one second application displayed on the second display is received, executing the selected second application on the first display.

12. The display control method of claim 10, wherein the determining of at least one second application comprises:
determining the at least one second application capable of executing the task by using the at least one item, based on information about an attribute of an application.

13. The display control method of claim 10, wherein the outputting of a menu comprises:
if a new application is downloaded at the electronic device, checking an attribute of the new application; and
if the checked attribute of the new application corresponds to an attribute of the first application, inserting the new application into the menu, and outputting, on the second display, the menu including the new application.

14. The display control method of claim 10, wherein the at least one item corresponds to a selection menu for providing a menu selectable in performing the task.

15. The display control method of claim 10, wherein the at least one item corresponds to a control menu for controlling a function of the first application.

16. The display control method of claim 10, wherein the second display is in an area of the electronic device viewable at an angle in which the first display is not viewable.
